(19) United States
(12) Patent Application Publication
(10) Pub. No.: US 2004/0216574 A1
(43) Pub. Date: Nov. 4, 2004

(54) Portable device for holding, sizing and cutting unrolled or flat media

(75) Inventor: Bruce Chabansky, Palo Alto, CA (US)

Correspondence Address: BRUCE CHABANSKY, 2850 MIDDLEFIELD RD., UNIT 334D, PALO ALTO, CA, 94306, US

(73) Assignee: Bruce Chabansky, Palo Alto, CA (US)

(21) Appl. No.: 10/249,708

(22) Filed: May 1, 2003

(51) Int. Cl. B26D 5/08

(52) U.S. Cl. 83/574

(57) ABSTRACT

The present invention relates to a device for keeping in place rolled media, while pulling the leading edge of the media, then holding the unrolled or flat media, (herein referred to as “media”) in place. The media could be made from, but is not limited to, materials such as paper, plastic, metal, or fabric. This is done while measuring a desired length from the leading edge and cutting the measured portion of the media. The invention provides a portable, safe, easy, and convenient device for handling, uncurling, sizing and cutting a desired portion of the media.

### BACKGROUND OF INVENTION

Rolled media, such as a wrapping paper roll, is often easy to store but difficult to manipulate while pulling and sectioning off a desired straight portion of it. As the media is pulled from the roll, an unsecured roll tends to unroll further away from the leading edge. Usually some help is required to hold the rolled media in place while pulling, measuring and cutting off a desired straight section of it.

Prior art discloses a variety of devices for holding and cutting off desired portions of media. Invariably, prior art devices include some means to fasten rolled media into a fixed position so that it may rotate freely only over its longitudinal axis without moving at the same time when it is pulled from its leading edge. Some of the common means of maintaining the rolled media in a fixed position while permitting it to freely rotate over its axis include positioning pins placed at the edges of the roll, a partial or full axle placed through the rolled media's core, or boxes that partially or fully enclose the rolled media.

Some media may develop hysteresis (memory from being in rolled form), so when unrolled the flattened portion will tend to curl back into the roll if it is not secured properly. The hysteresis effect may present further difficulties in the handling of the desired unrolled portion and subsequent severance from the roll. A variety of solutions have been formulated to solve the problem of holding the unrolled portion of the media in place so that it can be easily measured and cut.

Cutting off a desired portion of media may involve the use of a variety of cutting instruments ranging from a knife-like instrument or scissors, to a paper guillotine or numerically controlled lasers. Those devices have a risk of injury while using them to cut the media.

### SUMMARY OF INVENTION

The primary objective of the present invention is to provide a portable device for handling, measuring, fixing in place and cutting a straight portion of media to size in an efficient, safe and easy manner.

Another objective of the invention is to provide a portable device for handling, uncurling, measuring, fixing in place and cutting a straight portion of wrapping paper to size in an efficient, safe and easy manner.

Another objective of the invention is to provide a working surface (herein called the “tray”), for keeping rolled media in place while pulling the leading edge of the media.

Another objective of the invention is measuring a desired length from the leading edge and cutting the measured portion of the media.

Another objective of the invention is to provide a safe cutting tool (herein called the “cutter”), for use in conjunction with the tray to obtain a consistent and straight clean cut of a desired portion of the media.

Another objective of the invention is to provide a secure storage place for the cutter within the tray.

Another objective of the invention is to provide a portable tool for handling, fixing to place, measuring and cutting flat media to size.

Another objective of the invention is to provide a portable integral tool for dispensing and cutting adhesive tape.

Another objective of the invention is to provide a portable tool for uncurling previously rolled media that may have developed hysteresis.

Other features and advantages of the invention may become apparent upon review of the following drawings, detailed description and appended claims.

### BRIEF DESCRIPTION OF DRAWINGS

FIG. 1 is a perspective view of the tray shown fully expanded

FIG. 2 is a perspective view of the cutter.

FIG. 3 is a perspective view of the cutter in conjunction with the tray and a media.

FIG. 4 is a perspective view of the tray folded in half with the cutter placed in the storage area within the tray.

FIG. 5 is a perspective view of the tray with optional area for dispensing adhesive tape.

### DETAILED DESCRIPTION

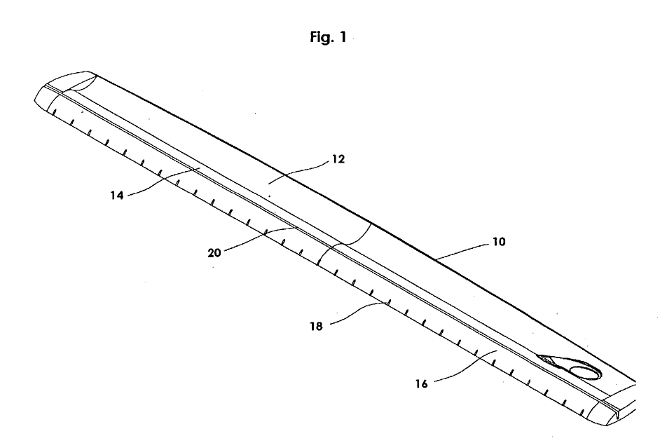

FIG. 1 provides a perspective view of the tray 10 shown fully expanded. The tray is a long extrusion shaped in a form that permits the positioning, uncurling, measuring, cutting and dispensing of a desired section of rolled or flat media (not shown). The tray 10 may be folded In half for handling smaller sized rolls of media and for easy transport and storage. Tray 10 has several sections. The positioning section 12 enables rolled media (not shown) to stay in place while rotating freely over its longitudinal axes. Positioning section 12 has a “U”-like (concave) cross-section, which could be either polygonal or circular, where the rolled media is able to rotate freely and stay in place when pulled from the leading edge of the media. The positioning section 12 may be dimensioned to accommodate a varied range of sizes of rolled media, both in length and diameter. The uncurling section 14 has “â [symbol] ”like (convex) cross-section, which could be either polygonal or circular, that runs the full length and alongside the positioning section 12. Uncurling section 14 permits the unrolled media to be stretched over its top surface and thus provides a negative curl to the media in order to overcome the hysteresis created when it was rolled. The uncurling section 14 also allows the user to tighten the media to the top surface of the tray 10 so that the media can stay tightly in place while it is being cut. The measuring section 16 consists of a means to measure the media's width and length. To measure the unrolled media on its width, calibrated markings 18 are placed on the top surface of the tray. To measure the length of unrolled media the tray 10 may incorporate, as a built-in or as a detachable accessory, a measuring device (not shown) such as, for example and without limitation, a self-winding measuring tape. The measurement section 16 may use calibrated markings corresponding to those of the ISO metric system, US metric system or other arbitrary measurement as desired. The cutting channel 20 is located in front of the positioning section 12 and uncurling section 14 of tray 10. The cutting channel 20 may run the length of the tray 10.

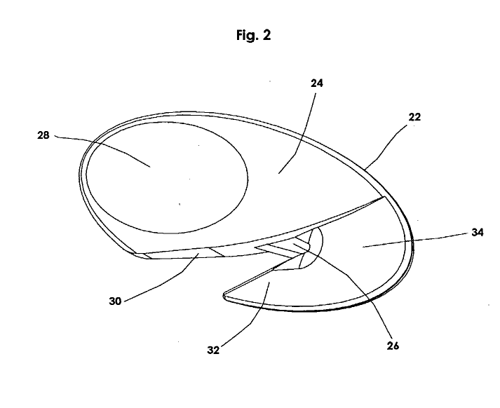

FIG. 2 shows a perspective of the cutter 22. The cutter 22 consists of two elements, a body 24 and a cutting blade 26. The body 24 has several sections. The holding section 28 permits the handling of the cutter by having sufficient surface to comfortably hold the tool with one hand. The sliding section 30 is the surface where the cutter 22 and the upper surface of the cutting channel 20 come in contact. This sliding section 30 is dimensioned so that at least a portion of the holding section 28 is wider than the cutting channel 20 width, so that the cutter 22 may glide over the cutting channel 20 in a smooth fashion. Part of the sliding channel is flat so that upon placing the guiding section 34 inside the cutting channel 20, the angle between the cutter blade 26 and the media is optimal and stays constant while the cutter 22 is moving along the length of the cutting channel 20. The blade-protecting area 32 surrounds the cutting blade 26 to protect the user from being accidentally exposed to the cutting blade 26. The guiding section 34 thickness allows the cutter 22 to be placed and glide freely inside the cutting channel.

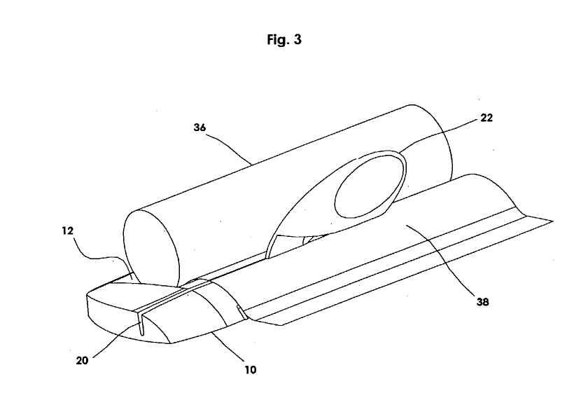

FIG. 3 shows a perspective of the rolled media 36 placed inside the positioning section 12 of tray 10 with a portion of the rolled media 36 being unrolled (unrolled media 38). The cutter 22 is seated inside the cutting channel 20, severing part of the unrolled media 38 from the rolled media 36.

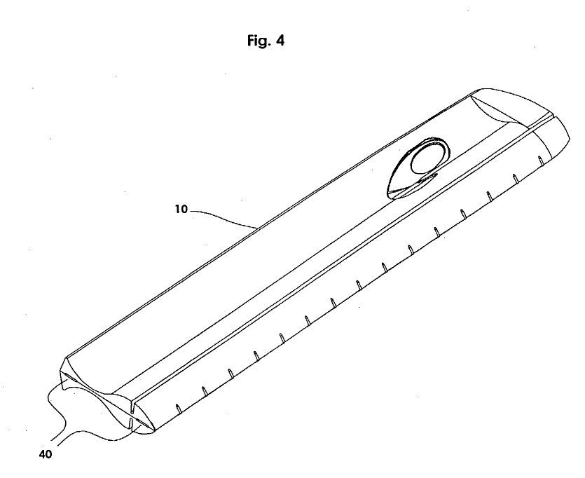

FIG. 4 illustrates a perspective of the tray 10 folded in half. For easy transportation and storage, the tray 10 may be provided with a hinge 40 that allows the folding of the tray 10 in two. A user may also want to use the tray 10 folded in two when the length of the rolled media is shorter than half of the length of the positioning section 12.

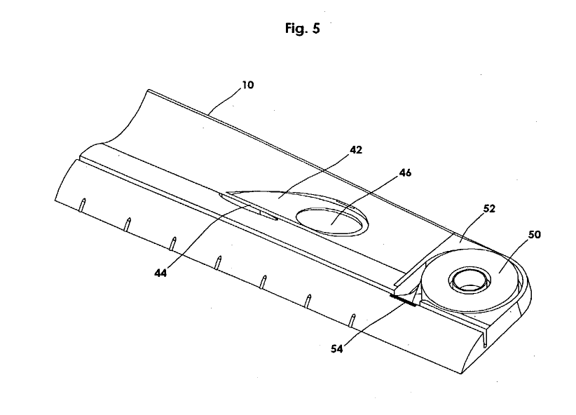

FIG. 5 shows an optional adhesive tape receptacle area 52 for dispensing adhesive tape 50 and a serrated edge 54 for severing a desired portion thereof. The tape dispenser receptacle area 52 may be optionally incorporated into the tray 10 for the purpose of having an integrated tool that provides a solution for cutting and packaging media with adhesive tape. Often separate pieces of a single device soon part ways unless proper and convenient storage is provided. FIG. 5 shows a perspective of the storage area 42 for the cutter 22 (not shown) within the tray 10. The cutter 22 (not shown) is inserted, blade protecting area 32 first, through a slot 44 in the tray. The slot 44 and the storage area are dimensioned to permit the insertion and swiveling of the cutter 22 (not shown) into the stored position. The cutter storage area 42 is built as a depression in the tray 10 and dimensioned to tightly fit and hold the cutter 22 in place. An opening 46 at the bottom of the storage area 42 permits the insertion of a finger (not shown) so that with the finger exercising pressure on the cutter 22, it can be removed from the storage area 42.

Although the invention has been described in conjunction with specific embodiments thereof, it is evident that many alternatives, modifications and variations will become apparent. Accordingly, the invention as described and hereinafter claimed is intended to embrace all such alternatives, modifications and variations that fall within the spirit and broad scope of the appended claims.

For example and without limitation, the device could be made of different materials such as plastic, metal, ceramic and cardboard. Similarly, the device could be made of different colors, shapes and dimensions. Additionally, while the description of the invention refers to rolled media, the tray may be used to size and cut flat sheets of media with equal convenience and results. Furthermore, the uncurling section 14 of the tray 10 may be used to uncurl previously rolled media 36 without being severed. Also, alternative storage may be used for the cutter 22.

What I claim as my invention is:

1. A portable tray for holding, sizing and provides for cutting rolled or flat media comprising of:
a positioning section for placing rolled media,
an uncurling section for uncurling rolled media, and
a cutting channel.

2. A cutter for cutting rolled or flat media comprising of:
a holding area for manipulating the cutter,
a sliding area for sliding the cutter in the cutting channel,
a blade-protecting area to protect the user from accidental cuts, and
a blade that slides through the cutting channel to effect a cut on the media.

3. A portable device according to claims 1 and 2, wherein a storage section in the tray for housing the cutter comprising:
a cavity that secures the cutter, and
a hole for permitting a finger to dislodge the cutter from the cavity.

4. A tray according to claim 1, which has one or more hinges positioned along the tray that enable it to fold.

5. A tray according to claim 1, wherein calibrated measuring marks are disposed alongside the device in a scale measured from a predetermined cut line.

6. A tray according to claim 1, that has calibrated measuring means extending outwards from the tray.

7. A tray according to claim 1, which has
a dispenser section to accommodate adhesive tape and
a cutting device to sever a desired portion thereof.
